(19) United States
(12) Patent Application Publication
(10) Pub. No.: US 2006/0272125 A1
(43) Pub. Date: Dec. 7, 2006

(54) Retention barrier for opened vehicle door

(76) Inventor: Marshall F. Yoakum, San Marcos, CA (US)

Correspondence Address: WILLIAM W. HAEFLIGER, 201 S. LAKE AVE, SUITE 512, PASADENA, CA, 91101, US

(21) Appl. No.: 11/371,123

(22) Filed: Mar. 9, 2006

Related U.S. Application Data
(60) Provisional application No. 60/687,196, filed on Jun. 2, 2005.

(51) Int. Cl. E05F 5/02; E05B 15/02

(52) U.S. Cl. 16/82; 292/340; 180/287

(57) ABSTRACT

The method of displaying a vehicle interior while effectively blocking viewer entry into the vehicle, that includes the steps, opening the vehicle door to a selected interior display position, providing an opened door retention strut, such as a bar or rod acting as a barrier to entry to the vehicle interior, that strut having opposite ends configured to interfit vehicle structure element such as the door frame, and also the vehicle body frame, and locating the strut in adjusted position relative to the door opening, so that the configured ends of the strut removably interfit those elements, with positioning of the strut to act as an unobtrusive barrier to viewer entry to the vehicle interior, via the door opening.

This application claims priority from provisional application Ser. No. 60/687,196, filed Jun. 2, 2005.

### BACKGROUND OF THE INVENTION

This invention relates generally to enablement of display and viewing of vehicle attractive interiors, as at locations of vehicle display, without incurring damage to such interiors as by accessing of viewers into the vehicle interiors.

There is need for ways to display attractive, original or refurbished interiors, and to maximum extent, without risk of injury or damage to such interiors. Given the opportunity, viewers tend to enter the vehicle passenger compartments, and manipulate the vehicle controls, which can lead to scratched or soiling of surfaces, and other damage. Such undesirable results tend to increase when viewers are able to open vehicle doors to better view the interiors.

### BRIEF SUMMARY OF THE INVENTION

It is a major object of the invention to provide a simple, effective solution to the above problem, and to meet the described need. This object is attained by provision of a method for displaying a vehicle interior with full effect, while effectively and unobtrusively blocking entry to the vehicle. The method includes the steps:

a) opening the vehicle door to a selected interior display position,
b) providing an opened door retention strut, such as a bar or rod acting as a barrier to entry to the vehicle interior, that strut having opposite ends configured to interfit vehicle structure elements such as the door frame, and also the vehicle body frame,

c) and locating the rod in adjusted position relative to the door opening, so that the configured ends of the strut removably interfit those elements, with positioning to act as an unobtrusive barrier to entry to the vehicle interior.

Another object includes provision of strut opposite ends having bent shapes to accommodate to the door or frame elements existent on a vehicle and to contribute to rod strengthening. Such shapes may include a hook and a bend or bends at one end of the rod and a straight section of the rod at its opposite end.

A further object includes provision of non-metallic protective caps at opposite ends of the rod-like strut, preventing damage to door and/or frame structure engaged by the strut. Provision for loose reception of the configured rod ends with the door and/or frame structure contributes to protection of engaged surfaces.

A further object includes provision of rod opposite end portion that are bent relative angularly, about the rod axis, as well as along the rod length.

These and other objects and advantages of the invention, as well as the details of an illustrative embodiment, will be more fully understood from the following specification and drawings, in which:

### DRAWING DESCRIPTION

FIGS. 1, 3, 5 and 7 are side views of different yet similar struts incorporating the invention;

FIGS. 2, 4, 6 and 8 are views taken on lines 2-2, 4-4, 6-6, and 8-8 of FIGS. 1, 3, 5 and 7, respectively; and

FIG. 9 is a perspective view showing a vehicle opened door and strut installation, barring entry to a widely or fully viewed vehicle interior.

### DETAILED DESCRIPTION

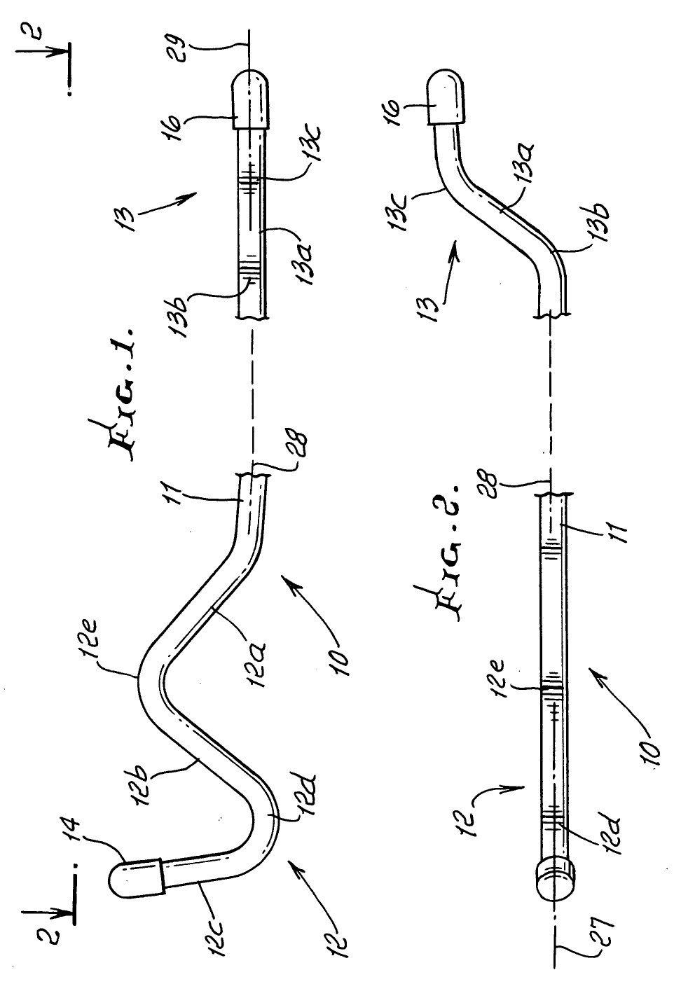

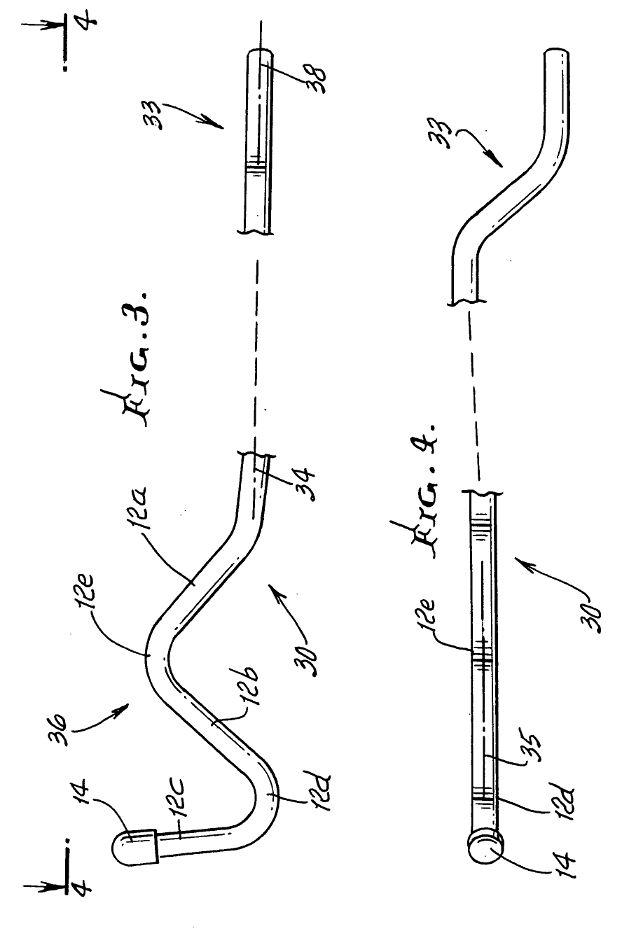

FIGS. 1 and 2 show a preferred metallic strut 10 in the form of an elongated cylindrical rod 11 having opposite end portions 12 and 13. End portion 12 has an S-shaped bend configuration, with first, second and third bent lengths 12a, 12b and 12c connected by U-shaped bends 12d and 12e. The portion 12 terminates at an end protectively covered by a plastic cap 14. End portion 13 has a bend length 13a between two bends at 13b and 13c. End portion 13 terminates at a protective plastic cap 16.

FIG. 9 shows rod 10 end portion 12 hooking over or into a vehicle body frame 17 element 17a, for example in the form of a U-shaped protruding door element retainer that normally holds the door closed. Rod end portion 13 may project into a cavity 19 in the frame 20 of the opened door. The rod 10 is accordingly positioned to bar entry into the exposed attractive interior 25 of the passenger compartment of the vehicle 26.

Not in FIGS. 1 and 2 that the bends of end portion 12 are in a plane 27 which is about 90° offset, about the rod axis 28 from the plane 29 of the bends of end portion 13, acting to stiffen the rod and to accommodate to the door and body frame.

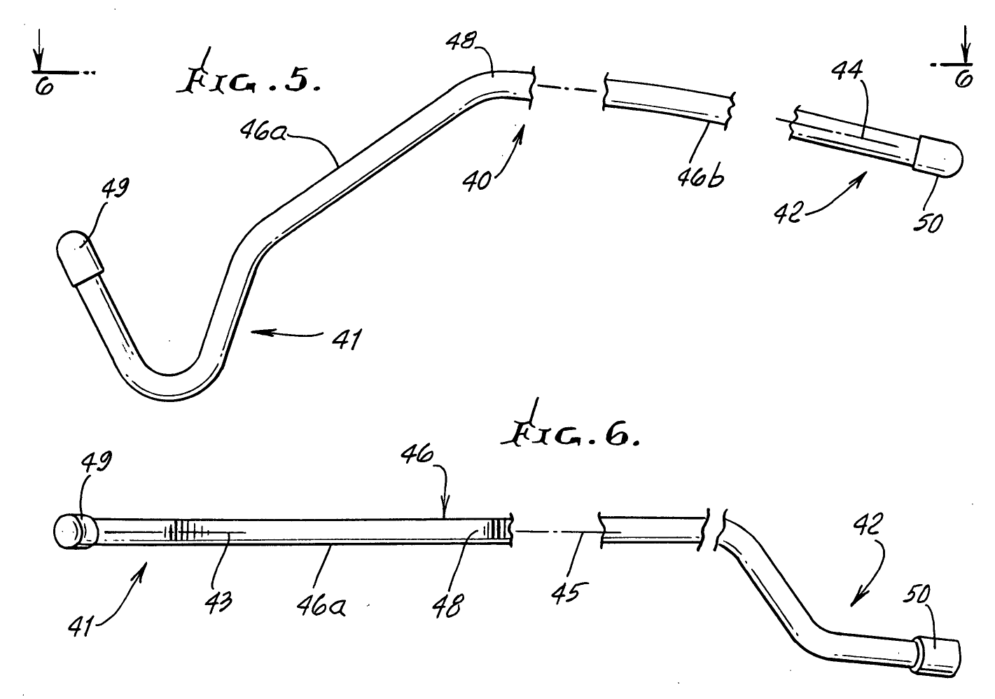

The strut 30 seen in FIGS. 3 and 4 is like that of FIGS. 1 and 2, excepting that the bends of rod end portion 33 are in a plane 38 about 90° offset about the rod elongated axis 34, and in the opposite rotary direction relative to the plane of 35 of the bends of rod end portion 36.

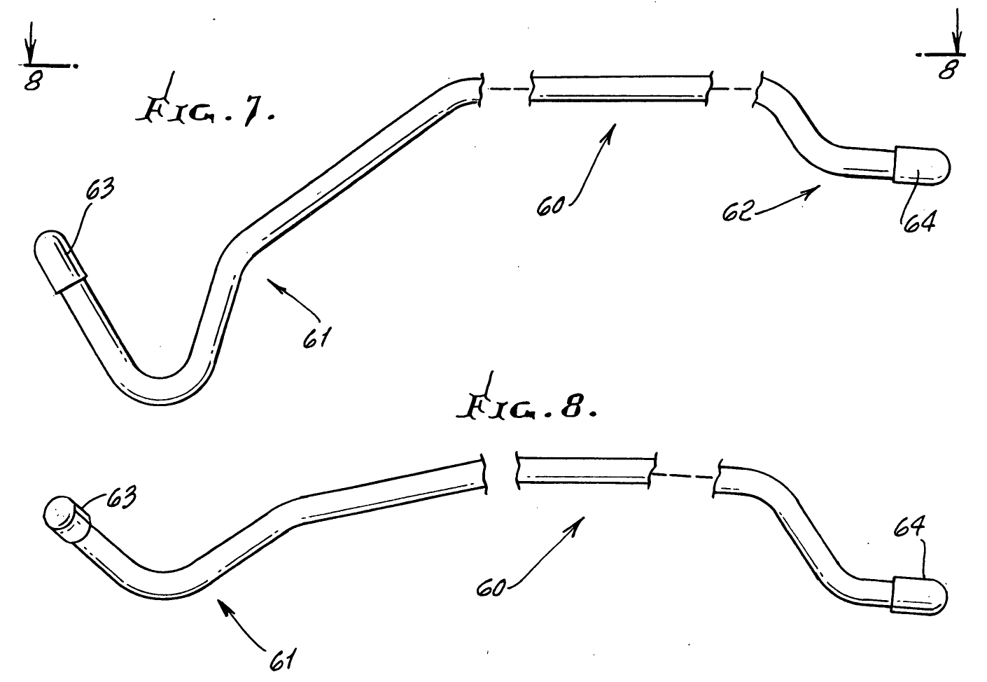

The strut 40 seen in FIGS. 5 and 6 has bent rod end portions 41 and 42 as shown, in planes 43 and 44, that are relatively rotated about the axis 45 of rod elongated intermediate portion 46. That intermediate portion has elongated sections 46a and 46b that are relatively sharply bent, as at bend location 48. See also rod end caps 49 and 50.

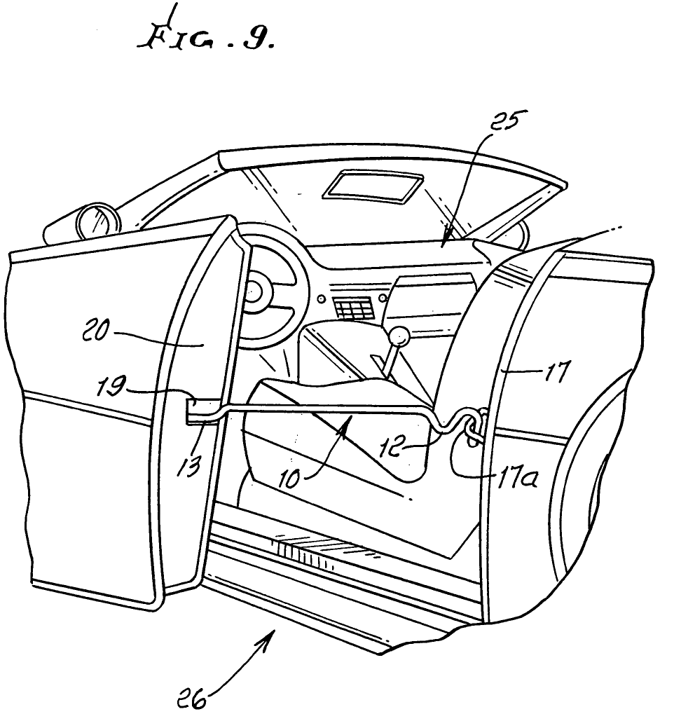

The strut 60 in FIGS. 7 and 8 has end portion 61 similar to end portion 41 seen in FIG. 6. Opposite end portion 62 is like bent end portion 42, but extends in a plane that is less than 90° rotated relative to the plane of end portion 61. The plane of end portion 61 is the plane of the drawing. See also end caps 63 and 64.

I claim:

1. The method of displaying a vehicle interior while effectively blocking viewer entry into the vehicle, that includes the steps:
a) opening the vehicle door to a selected interior display position,
b) providing an opened door retention strut, such as a bar or rod acting as a barrier to entry to the vehicle interior, that strut having opposite ends configured to interfit vehicle structure elements such as the door frame, and also the vehicle body frame,
c) and locating the strut in adjusted position relative to the door opening, so that the configured ends of the strut removably interfit those elements, with positioning of the strut to act as an unobtrusive barrier to viewer entry to the vehicle interior, via the door opening.

2. The method of claim 1 which includes providing the strut to have opposite ends relatively bent into shape or shapes to accommodate to interfit with door or frame elements on an existent vehicle.

3. The method of claim 1 including providing protective non-metallic end caps on opposite ends of the strut.

4. The method of claim 2 including providing said opposite ends to extend in planes which are relatively offset about a main axis defined by the strut.

4. The method of claim 4 wherein said planes are relatively offset by about 90° about said main axis.

6. A vehicle opened door retention strut to act as a barrier to entry to a vehicle interior, comprising
a) the strut having opposite ends configured to interfit vehicle structure elements such as are on or associated with the door frame and also the vehicle body frame,
b) one of said opposite ends configured with a bend or bends in a first plane.

7. The retention strut of claim 6 wherein the other of said opposite ends is configured with a bend or bends in a second plane, said first and second planes relatively rotated about a main axis defined by the strut.

8. The strut of claim 6 including a protective non-metallic cap or caps on one or both ends of the strut.

9. The strut of claim 6 installed between said elements of an opened door of a vehicle and the vehicle frame.

10. The strut of claim 6 wherein said bend or bends define an S-shaped configuration.

11. The method of displaying a vehicle interior while effectively blocking viewer entry into the vehicle, that includes the steps:
a) opening the vehicle door to a selected interior display position,
b) providing an opened door retention strut, such as a bar or rod acting as a barrier to entry to the vehicle interior, that strut having opposite ends configured to interfit vehicle structure elements such as the door frame, and also the vehicle body frame,
c) and locating the strut in adjusted position relative to the door opening, so that the configured ends of the strut removably interfit those elements, with positioning of the strut to act as an unobtrusive barrier to viewer entry to the vehicle interior, via the door opening,
d) the strut configured to have opposite ends deformed relative to a strut axis and into shape or shapes to accommodate to interfit with door or frame elements on an existent vehicle.

12. The method of claim 1 including providing a protective non-metallic end cap on one end of the strut.

13. The method of claim 1 including providing said opposite ends to extend in planes which are offset relative to a main axis defined by the strut.

14. A vehicle opened door retention strut to act as barrier to entry to a vehicle interior, comprising
a) the strut having opposite ends configured to interfit vehicle structure elements such as are on or associated with the door frame and also the vehicle body frame,
b) one of said opposite ends configured with a bend or bends in a first plane,
c) the other of said opposite ends being configured with a bend or bends in a second plane, said first and second planes relatively rotated about a main axis defined by the strut.

15. The strut of claim 14 installed between said elements of an opened door of a vehicle and the vehicle frame.

16. The strut of claim 14 wherein said bend or bends define an S-shaped configuration.
